(19) United States
(12) Patent Application Publication
(10) Pub. No.: US 2017/0227322 A1
(43) Pub. Date: Aug. 10, 2017

(54) ELECTRONIC DEVICE MOUNTING SYSTEM FOR A WEAPON

(71) Applicant: Big Shot, LLC, Hawkins, TX (US)

(72) Inventors: Benjamin Franklin, Holly Lake Ranch, TX (US); Byron South, Big Sandy, TX (US)

(73) Assignee: Big Shot, LLC, Hawkins, TX (US)

(21) Appl. No.: 15/153,332

(22) Filed: May 12, 2016

Related U.S. Application Data
(60) Provisional application No. 62/292,643, filed on Feb. 8, 2016.

(51) Int. Cl. F41C 27/00; F41G 11/00; F16M 11/04; F16M 13/02; F16M 13/00

(52) U.S. Cl. CPC F41C 27/00; F16M 13/02; F16M 13/00; F16M 11/041; F41G 11/003

(57) ABSTRACT

A mounting system for securing an electronic device to a rifle, the mounting system includes a base member and a slider member. The slider member includes a plurality of bumper members extending therefrom, the slider member secured to the base member and movable between an extended position, to enable the electronic device to be inserted between at least a pair of bumper members, and a retracted position, to enable the bumper members to abut against and secure the electronic device to the mounting system.

### CROSS REFERENCE TO RELATED APPLICATIONS

This application claims the benefit of U.S. Provisional Patent Application No. 62/292,643, filed on Feb. 8, 2016, pending, which is hereby incorporated by reference in its entirety.

### FIELD OF THE INVENTION

The present inventions relates to the field of Electronic Wild Game Calls and related accessories, and in particular, to an apparatus to secure an electronic device to a weapon, such as, for example, a rifle.

### DESCRIPTION OF THE RELATED ART

Existing Electronic Wild Game Calls are highly customized devices with limited end-user options and control. Those Electronic Wild Game Calls do not provide for a complete and easy interaction between the device, the hunting weapon, and the user.

### SUMMARY OF THE INVENTION

In one embodiment, a mounting system for an electronic device includes a lockable MIL-1913 weapon interface, an adjustable span slider mechanism that includes a plurality of clamping bumpers. In some embodiments, the apparatus is secured to a standard accessory rail provided on some weapons, and in turn, an electronic device, such as, for example, a smartphone, is clamped to the mounting system. The smartphone runs an app controlling and viewing the Electronic Wild Game Call.

### BRIEF DESCRIPTION OF THE DRAWINGS

FIG. 1 is an isometric view of a mounting system.

FIG. 2 is a rear perspective view of the mounting system.

FIG. 3 is a rear perspective view of the mounting system.

FIG. 4 is a rear perspective view of the mounting system.

FIG. 5 is an isometric view of the mounting system illustrating the system supporting a cell phone device.

### DETAILED DESCRIPTION

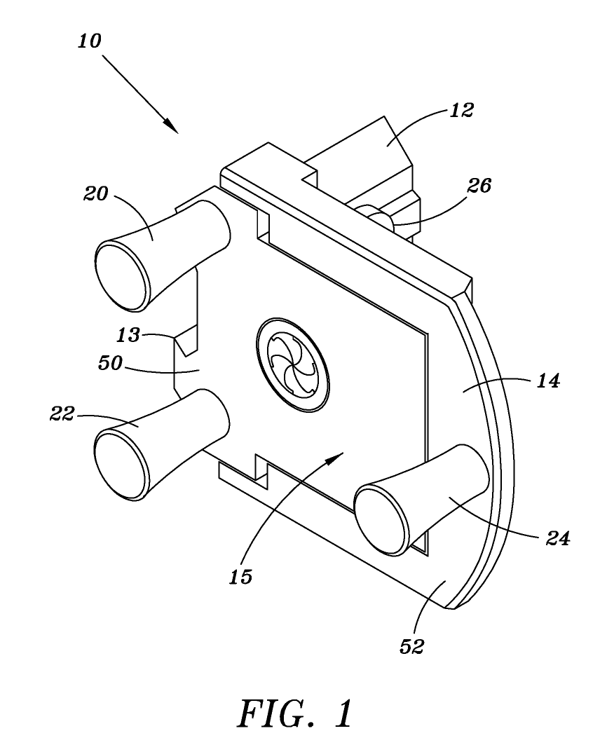

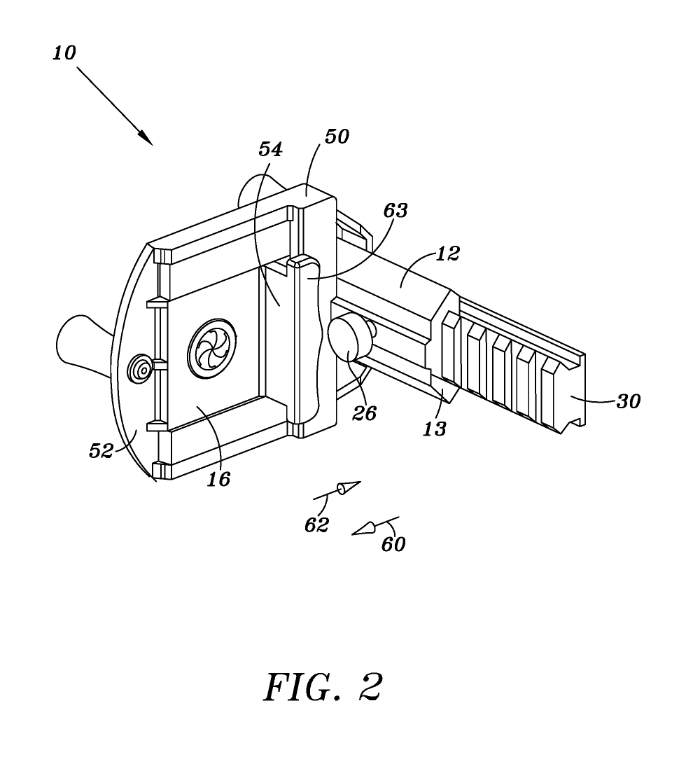

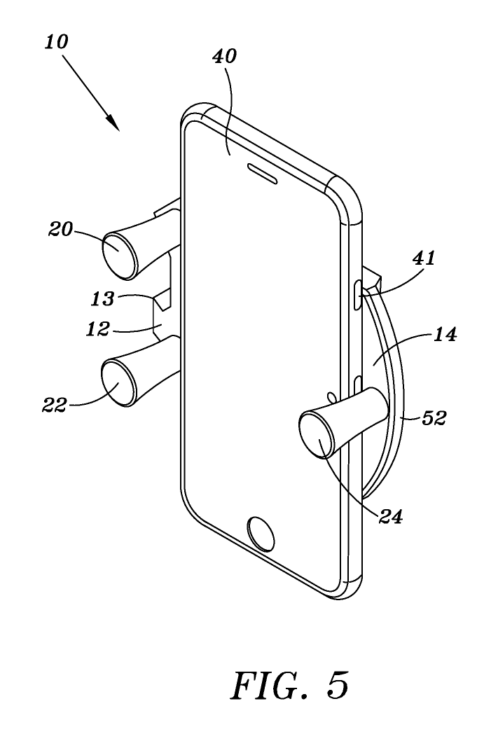

In the embodiment illustrated in FIGS. 1 and 2, an embodiment of a mounting system 10 is employed to support and otherwise attach an electronic device 40, such as, for example, a mobile phone or smartphone, to a weapon such as a hunting rifle. The mounting system 10 includes a base member 12, a slider member 14 having a planar surface support surface 15, and a plurality of bumper members 20, 22, and 24. In use, the planar support surface 15 along with the bumper members 20, 22 and 24 support the electronic device 40 on the mounting system 10, as best illustrated in FIG. 5. According to one embodiment, the base 12 and slider 14 are formed of rigid polymeric material and bumper members 20, 22, and 24 are formed of a semi-rigid rubber or synthetic rubber-like materials.

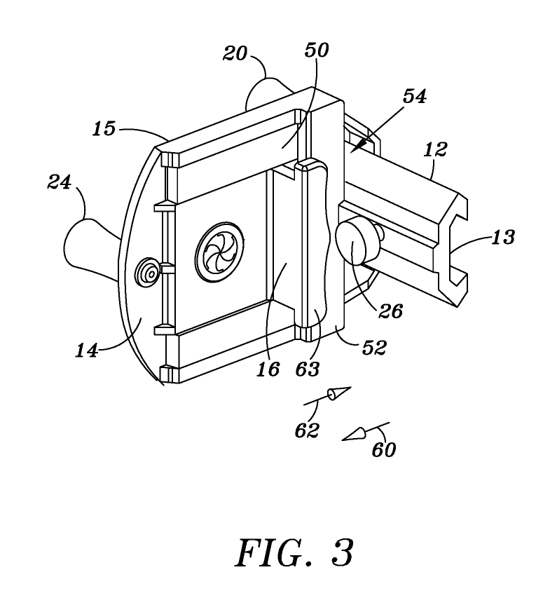

Referring specifically to FIGS. 2 and 3, the base 12 includes a track 13 configured to mate and otherwise connect to a support rail, such as, for example, a MIL-1913 “Picatinny” accessory rail 30, which are commonly installed on weapons. As illustrated, the track 13 is formed having a cross-sectional shape that corresponds to the cross sectional shape of the rail 30 to receive and support the rail 30 therein to enable sliding movement therebetween. During installation, the base member 12, and in particular, the track 13, is aligned with the rail 30 to enable the rail 30 to be inserted within the track 13. According to some embodiments, a thumb screw 26 or other locking device extends through the base member 12 and is extendible to contact and otherwise engage the rail 30 to secure the base 12, and thus the mounting system 10, to the rail 30 and prevent relative movement therebetween.

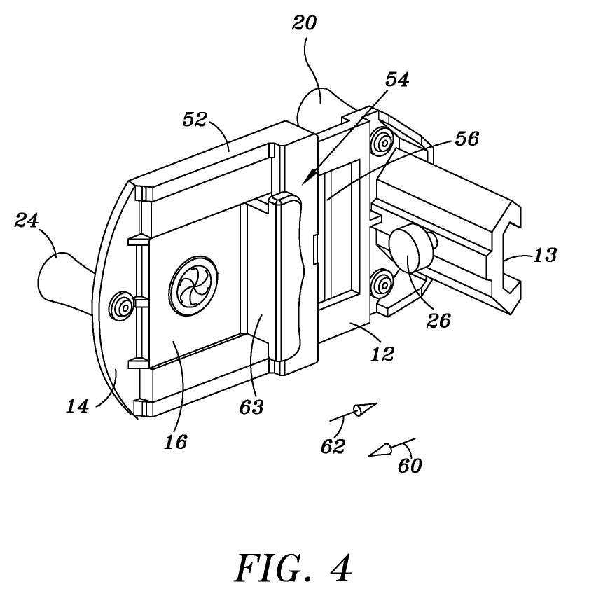

Referring specifically to FIGS. 3 and 4, the mounting system 10, and in particular, the slider 14, is positionable between a retracted position (FIG. 3) in which the bumpers 20, 22 and 24 are positioned in a first relative position in which the bumpers 20 and 22 are spaced apart a first distance from the bumper 24, and an extended position (FIG. 4), in which the bumpers 20 and 22 are positioned in a second relative position to the bumper 24 that is spaced further apart than the first relative position. For example, according to one embodiment, when the slider 14 is positioned in the retracted position, the bumpers 20 and 22 are spaced apart from the bumper 24 so that an electronic device 40 is secured in a vertical or “portrait” configuration (See FIG. 5). Similarly, when the slider 14 is positioned in an extended position, the bumpers 20 and 22 are spaced apart from the bumper 24 a distance greater than the distance in the retracted position so as to accommodate the electronic device 40 when secured in a horizontal or “landscape” position.

With continued reference to FIG. 4, the slider 14 is formed having telescoping members 50 and 52 each having planar surfaces to form the planar support surface 15. As illustrated, telescoping member 52 is slideable on the telescoping member 50 to enable the slider 14 to be positioned between the retracted and extended positions. According to some embodiments, a locking system 54 resists relative movement between the members 50 and 52 in the direction of arrows 60 and 62 (FIG. 4) to enable the slider 14 to secure the cell phone 40 onto the mounting system 10. In the embodiment illustrated in FIG. 4, the locking system 54 is formed having a plurality of spaced apart teeth 56 that frictionally engage a lever 16 so as to resist the relative lateral movement of the members 50 and 52. In the embodiment illustrated in FIG. 4, the telescoping member 50 includes the plurality of teeth 56 are spaced apart forming a groove therebetween to receive at least a portion of the lever 16 therein to prevent the relative lateral movement of the members 50 and 52. In the embodiment illustrated in FIG. 4, for example, the lever 16 is integrally formed with telescoping member 52 and is a flexible member biased such that at least a portion of the lever 16 engages the plurality of teeth 56. In operation, when it is desired to adjust the position of the slider 14, a lifting force is applied to the handle 62 in order to remove and otherwise retract the lever 16 from between the spaced apart teeth 56. Once in this position, the length of the slider 14, and thus the position of the bumpers 20, 22 and 24, is adjusted by moving member 52 relative to member 50 until a desired length is achieved. Once at the desired length, the handle 62 is released and biased toward the engaged position, in which the lever 16 engages and otherwise rests between the teeth 54. Additionally or alternatively, slider 14 is adjustable by simply applying a moving force to the member 52 in the direction of arrow 60 or 62, as applicable, to overcome the frictional force between the teeth 56 and the lever 16, thus, in some embodiments, the handle 62 is not necessary. It should be understood that locking system 54 may be otherwise configured. For example, in lieu of using a lever 16, members 50 and 52 can be secured to resist relative movement by utilizing fasteners such as screws or cotter pins. In other embodiments, the locking system 54 may utilize magnetic forces to resist relative movement between the members 50 and 52.

According to some embodiments, the slider can be expanded up to a full inch in 3/16 inch increments; however, it should be understood that the slider 14 can be expanded to even greater distances and at differing increments, as desired. In the embodiment illustrated in FIG. 1, telescoping member 50 has two bumper members 20 and 22 and telescoping member 52 includes one bumper member 24 extending therefrom. It should be understood, however, that the bumper members 20, 22 and/or 24 may be otherwise positioned on the slider member 14. For example, in some embodiments, only two bumper members 20 and 24 may be utilized. In other embodiments, telescoping member 52 may have more than one bumper member 24. In the embodiments disclosed herein, each bumper member 20, 22 and 24 are generally cylindrical post-like members having a gradually increasing diameter along their lengths, although, it should be understood that any shape or size bumper member may be utilized. For example, each bumper member 20, 22 and/or 24 may have an oval cross-sectional shape that includes a non-varying cross-sectional diameter along its length.

According to some embodiments, the bumpers 20, 22 and/or 24 are integrally formed with the slider 14. According to other embodiments, the bumper members 20, 22 and/or 24 are removably attachable to the slider 14. For example, according to some embodiments, the bumpers 20, 22 and/or 24 are threadably secured to the slider 14. In other embodiments, the bumpers 20, 22 and/or 24 frictionally engage and are secured in a corresponding opening on the slider 14. According to other embodiments, one or more of the bumpers 20, 22 and/or 24 are supported within an elongate slot disposed on the slider 14 such that if it is desired to adjust the position the bumper 20, 22 and/or 24 relative to the slider 14, a bumper 20, 22 and/or 24 can be repositioned within the corresponding slot at the desired position. This enables the bumpers to be repositioned to enable the slider 14 to accommodate a variety of electronic devices 40 that feature side buttons 41 (FIG. 5) in different locations. This will ensure that the bumper members 20, 22 and/or 24 do not block or otherwise prevent access to the buttons 41 on the electronic device 40 when secured to the mounting system 10.

According to some embodiments, when it is desired to secure an electronic device 40 to the mounting system 10, the locking system 54 is unlocked, as previously discussed, and the telescoping member 52 is spaced apart a distance slightly wider than the width of the electronic device 40 in an extended position. A user then positions the electronic device 40 between the bumpers 20, 22 and 24 and slides the telescoping member 52 such that the bumpers 20, 22 and 24 abut the electronic device 40 in a retracted position.

What is claimed is:

1. A mounting system for securing an electronic device to a rifle, the mounting system comprising:
a base member; and
the slider member having a plurality of bumper members extending therefrom, the slider member secured to the base member and movable between an extended position, to enable the electronic device to be inserted between at least a pair of bumper members, and a retracted position, to enable the bumper members to abut against and secure the electronic device to the mounting system.

2. The mounting system of claim 1, wherein the slider member includes a first member and a second member slideably mounted to the first member to enable the slider member to be movable between the retracted and extended positions.

3. The mounting system of claim 1, wherein the slider member includes a locking system, the locking system including lever biased into frictional engagement with a plurality of teeth.

4. The mounting system of claim 3, wherein the lever includes a handle to enable a user to position the lever out of engagement with the plurality of teeth.

5. The mounting system of claim 1, wherein the base member includes a track to engage an accessory rail on a weapon.

6. T The mounting system of claim 5, wherein the accessory rail is a MIL-1913 Picatinny accessory rail.

7. The mounting system of claim 5, wherein base member includes a locking mechanism to secure the base member to the accessory rail and prevent separation therebetween.

8. The mounting system of claim 7, wherein the locking mechanism includes an extendible member to frictionally engage the accessory rail.

9. The mounting system of claim 1, wherein the plurality of bumper members include a plurality of spaced apart post members extending outward from the slide member.

10. The mounting system of claim 2, wherein the first member includes a bumper member and the second member includes a bumper member.
